(19) United States
(12) Patent Application Publication
(10) Pub. No.: US 2011/0197845 A1
(43) Pub. Date: Aug. 18, 2011

(54) PISTON ASSEMBLY

(76) Inventors: William Flowers, Ann Arbor, MI (US); Dieter Gabriel, Highland, MI (US); Grace Zhao, Novi, MI (US); Ralph Klein, Plymouth, MI (US)

(21) Appl. No.: 12/898,300

(22) Filed: Oct. 5, 2010

Related U.S. Application Data
(60) Provisional application No. 61/305,445, filed on Feb. 17, 2010.

(51) Int. Cl. F02F 3/16; F16J 1/04; B23P 15/10

(52) U.S. Cl. 123/193.6; 92/231; 29/888.043

(57) ABSTRACT

An exemplary piston assembly and method of making the same are disclosed. A piston assembly may include a piston crown and piston skirt. The crown may include a ring belt portion defining at least in part a cooling gallery, as well as radially inner and outer crown mating surfaces. The skirt may be received in a central opening of the crown such that the crown and skirt cooperate to form an upper combustion bowl surface. The skirt also may include radially inner and outer skirt mating surfaces that are abutted with the inner and outer crown mating surfaces, respectively, such that the cooling gallery is generally enclosed by the skirt.

### CROSS-REFERENCE TO RELATED APPLICATIONS

This application claims the benefit of U.S. Provisional Application Ser. No. 61/305,445, filed on Feb. 17, 2010, the contents of which are hereby expressly incorporated herein by reference in its entirety.

### BACKGROUND

A power cylinder assembly of an internal combustion engine generally comprises a reciprocating piston disposed within a cylindrical cavity of an engine block. One end of the cylindrical cavity may be closed while another end of the cylindrical cavity may be open. The closed end of the cylindrical cavity and an upper portion or crown of the piston defines a combustion chamber. The open end of the cylindrical cavity permits oscillatory movement of a connecting rod, which joins a lower portion of the piston to a crankshaft, which is partially submersed in an oil sump. The crankshaft converts linear motion of the piston (resulting from combustion of fuel in the combustion chamber) into rotational motion.

Frictional losses decrease overall efficiency of the power cylinder. For example, friction between the piston and cylindrical cavity reduce the amount of power transferred from the combustion of intake gases to an output shaft of the power cylinder. Accordingly, friction must be minimized in order to maximize overall engine efficiency, e.g., by minimizing weight of the piston, increasing lubrication about cylinder bores, and/or increasing combustion temperatures and pressures. Additionally, manufacturers are constantly seeking ways to increase production flexibility and reduce manufacturing costs.

Engines, and in particular the pistons, are therefore under increased stress as a result of these reductions in weight, increased pressures and temperatures associated with engine operation, and efforts to simplify piston assemblies to improve manufacturing efficiency. Piston cooling is therefore increasingly important for withstanding the increased stress of such operational conditions over the life of the engine. To reduce the operating temperatures of piston components, a cooling gallery may be provided about a perimeter of the piston. Crankcase oil may be introduced to the cooling gallery, and may be distributed about the cooling gallery by the reciprocating motion of the piston, thereby reducing the operating temperature of the piston. The provision of cooling galleries, however, may also increase manufacturing complexity.

Accordingly, there is a need for a piston that minimizes manufacturing complexity while reducing frictional losses associated with movement of the piston within the engine bore and also allowing adequate cooling, such as by providing a cooling gallery.

### BRIEF DESCRIPTION OF THE DRAWINGS

While the claims are not limited to the illustrated examples, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows:

FIG. 1A illustrates a partial cutaway view of an exemplary piston assembly;

FIG. 1B illustrates an enlarged portion of the partial cutaway view of FIG. 1A;

FIG. 2 illustrates a cutaway view of exemplary welds between a piston crown and skirt;

FIG. 3 illustrates a partial cutaway view of an exemplary piston having a lubrication passage extending between a piston cooling gallery and a skirt outer surface of the piston;

FIG. 4A is a perspective view of the exemplary piston shown in FIG. 3;

FIG. 4B is a cutaway view of an exemplary piston skirt having a passageway extending between a piston cooling gallery surface and a skirt outer surface;

FIG. 4C is a cutaway view of another exemplary piston skirt having a passageway extending between a piston cooling gallery surface and a skirt outer surface;

FIG. 5 is a section view of an exemplary piston assembly having weld spatter traps; and

FIG. 6 is a process flow diagram of an exemplary method of making a piston assembly.

### DETAILED DESCRIPTION

Reference in the specification to “an exemplary illustration”, an “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

Various exemplary illustrations are provided herein of a piston assembly that includes a piston crown and piston skirt. The crown may include a ring belt portion defining at least in part a cooling gallery, as well as radially inner and outer crown mating surfaces. The skirt may be received in a central opening of the crown such that the crown and skirt cooperate to form an upper combustion bowl surface. The skirt also may include radially inner and outer skirt mating surfaces that are abutted with the inner and outer crown mating surfaces, respectively, such that the cooling gallery is generally enclosed by the skirt.

An exemplary method of making a piston assembly may include providing a piston crown that includes a ring belt portion defining at least in part a cooling gallery, as well as radially inner and outer crown mating surfaces. The method may further include receiving a piston skirt in a central opening of the crown such that the crown and skirt cooperate to form a continuous upper combustion bowl surface. The piston skirt may include radially inner and outer skirt mating surfaces. The method may further include abutting the skirt to the crown along the corresponding radially inner and outer mating surfaces of the skirt and crown, the skirt thereby generally enclosing the cooling gallery.

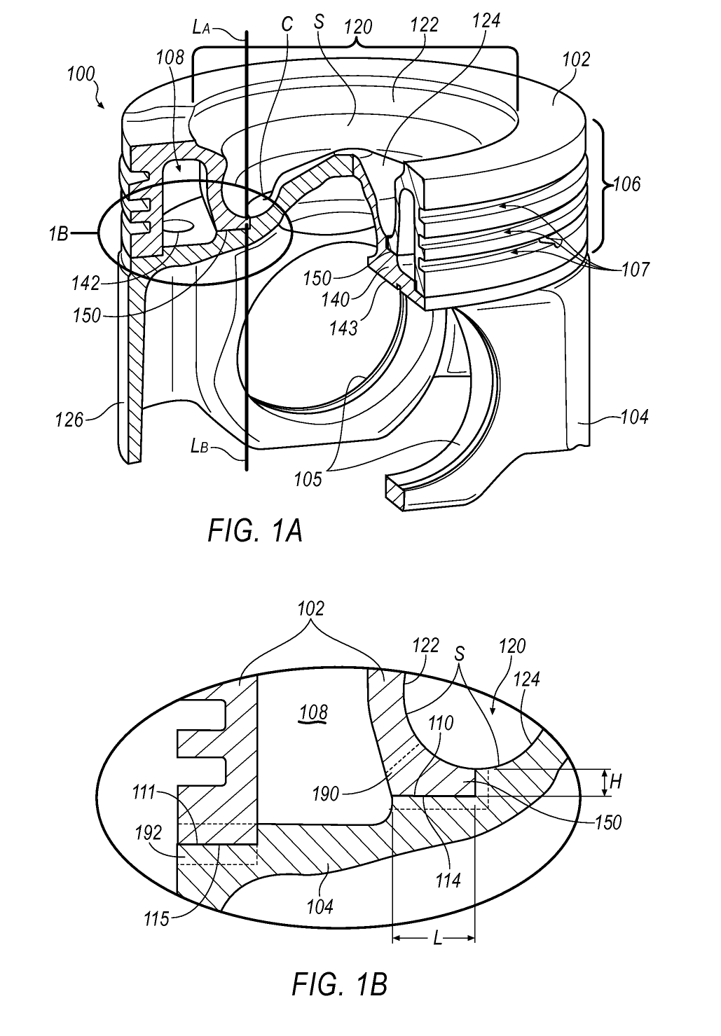

Turning now to FIG. 1, an exemplary piston assembly 100 is illustrated. Piston assembly 100 may include a piston crown 102 and a piston skirt 104 that is received in a central opening C defined by the crown 102. The piston crown 102 may include a combustion bowl 120 and a ring belt portion 106 that is configured to seal against an engine bore (not shown) receiving the piston assembly 100. For example, the ring belt portion 106 may define one or more circumferential grooves 107 that receive piston rings (not shown), which in turn seal against engine bore surfaces during reciprocal motion of the piston assembly 100 within the engine bore.

The piston skirt 104 generally supports the crown 102 during engine operation, e.g., by interfacing with surfaces of an engine bore (not shown) to stabilize the piston assembly 100 during reciprocal motion within the bore. For example, the skirt 104 may have an outer surface 126 that generally defines a circular outer shape about at least a portion of a perimeter of the piston assembly 100. The outer shape may correspond to the engine bore surfaces, which may be generally cylindrical. The circular skirt surfaces 126 may generally slide along the bore surfaces as the piston moves reciprocally within the bore. Accordingly, the skirt outer surfaces 126 may be textured to promote lubrication and/or reduce friction between surfaces of the skirt 104 that interface with an engine bore surface.

The skirt 104 may also define piston pin bosses 105. The piston pin bosses 105 may generally be formed with apertures configured to receive a piston pin (not shown). For example, a piston pin may be inserted through the apertures in the piston pin bosses 105, thereby generally securing the skirt 104 to a connecting rod (not shown).

The ring belt portion 106 of the crown 102 may define, at least in part, a cooling gallery 108. The cooling gallery 108 generally extends about a perimeter of the piston crown 102, and may circulate a coolant during operation, e.g., engine oil, thereby reducing an operating temperature of the piston. Additionally, the circulation of the coolant may facilitate the maintaining of a more stable or uniform temperature about the piston 100, and especially in the upper portion of the piston assembly 100, e.g., the crown 102 and combustion bowl 120.

The cooling gallery 108 may be generally enclosed entirely within the crown 102. For example, the cooling gallery 108 may be enclosed by an upper portion 140 of the skirt 104. More specifically, the upper skirt portion 140 may form a lower boundary of the cooling gallery 108, thereby enclosing the cooling gallery 108 within the crown 102, and preventing coolant from freely entering and escaping the cooling gallery 108. At the same time, one or more apertures 142 may also be provided to allow oil or other coolants to exit and enter the cooling gallery 108 to/from the engine (not shown) in a controlled manner, thereby further reducing and/or stabilizing operating temperatures associated with the piston 100 and components thereof.

The crown 102 and skirt 104 may be secured to each other in any manner that is convenient. In one exemplary illustration, the crown 102 and the skirt 104 may each define radially inner and outer mating surfaces 110, 111, 114, and 115 that each extend about at least a portion of a circumference of the crown 102 and skirt 104, respectively. More specifically, the crown 102 may define radially inner and outer crown mating surfaces 110, 111, respectively, that generally extend about a periphery of the crown 102. The skirt 104 may define radially inner and outer skirt mating surfaces 114, 115, which also extend about a periphery of the piston assembly 100 and/or skirt 104, and generally correspond to the crown mating surfaces 110, 114 as will be described further below.

As best seen in FIG. 1B, the radially inner mating surfaces 110, 114 may generally abut within a radially inner interface region 190, while the radially outer mating surfaces 111, 115 may generally abut within a radially outer interface zone 192. In other words, the radially inner interface region 190 may include the radially inner mating surfaces 110, 114 of the crown 102 and skirt 104, respectively. Further, the radially outer interface region 192 may include the radially outer mating surfaces 111, 115 of the crown 102 and skirt 104, respectively. Where the crown 102 and skirt 104 are fixedly secured, the crown 102 and skirt 104 may be secured to each other via one of both of the interface regions 190, 192.

The crown mating surfaces 110, 111 may generally define flat surfaces, at least when viewed in section as in FIG. 1B, that align with the corresponding radially inner and outer mating surfaces 114, 115 of the piston skirt 104. As will be described further below, the skirt mating surfaces 114, 115 and crown mating surfaces 110, 111 may each be aligned generally parallel to the corresponding mating surface on the other component, thereby facilitating abutment of the crown mating surfaces 110, 111 with the skirt mating surfaces 114, 115, respectively. One or both crown mating surfaces 110, 111 may be secured to their respective skirt mating surface 114, 115 in any manner that is convenient, e.g., by way of a welding operation or adhesive bonding, merely as examples, thereby securing the crown 102 and skirt 104 together.

The skirt 104 may secured to the crown 102 such that the crown 102 and the skirt 104 cooperate to form a continuous upper combustion bowl surface S in the combustion bowl area 120 of the piston assembly 100. For example, the corresponding mating surfaces 110 and 114 may meet within or adjacent the combustion bowl 120 such that the crown 102 defines a first radially outer portion 122 of the combustion bowl surface S, while the skirt 104 defines a radially inner portion 124 of the combustion bowl surface S.

The combustion bowl surface S may be substantially smooth across an interface between the skirt 104 and the crown 102, e.g., so that disruptions and/or discontinuities in the surface S are minimized. Minimizing such disruptions or discontinuities may generally reduce cracks or other loosening of an interface between the crown 102 and the skirt 104 along the mating surfaces 110 and 114 during normal long-term operation. Accordingly, any defects or failure in the combustion bowl surface S, e.g., due to wear occurring during operation of an engine using piston assembly 100, may be minimized. For example, machining operations may be employed prior to or after formation of piston assembly 100, e.g., welding of the crown 102 and skirt 104, to reduce surface irregularities in the combustion bowl surface S.

The piston crown 102 and the piston skirt 104 may be secured or fixedly joined to one another in any manner that is convenient including, but not limited to, welding methodologies such as beam welding, laser welding, soldering, or non-welding methodologies such as adhesive bonding, merely as examples. In one example, the piston crown and skirt are joined in a welding process, e.g., laser welding, that allows the weld tool to form a generally smooth combustion bowl surface 120 while operating upon the relevant weld joint in a longitudinal orientation, as will be described further below.

A laser welding operation may generally allow the formation of a solid metallic weld between the crown 102 and the skirt 104 while also minimizing the size of an associated heat affected zone. For example, a fiber optic laser may be employed. In one exemplary illustration, a weld laser is employed having a wavelength between approximately 200 and approximately 400 μm, and a power of 4.8 killiWatts (kW). The weld joint may also be preheated, and in one exemplary illustration is preheated to approximately 500 degrees Celsius.

A weld laser may generally be employed to propagate a heat affected zone adjacent the radially inner mating surfaces 110 and 114, e.g., within the radially inner interface region 190, thereby welding the crown 102 and the skirt 104 together about the radially inner mating surfaces 110, 114. Alternatively or in addition, a weld laser may generally be employed to propagate a heat affected zone adjacent the mating surfaces 111 and 115, e.g., within the radially outer interface region 192, thereby welding the crown 102 and the skirt 104 together about the mating surfaces 111, 115. Where any mating surfaces 110, 111, 114, or 115 are not welded together, they may be left in abutment with each other due to the securement of other mating surfaces, or may be secured via another method, e.g., bonding, mechanical fastening, etc.

In one exemplary illustration, a series of welds are made along the circumferential extent of the radially inner mating surfaces 110, 114. Alternatively, a weld laser may be used in a generally continuous welding process extending substantially about the entire circumference of the radially inner mating surfaces 110, 114, such that the weld formed also extends substantially about the entire crown 102 and skirt 104.

Where the crown 102 and skirt 104 are secured together, e.g., by welding, the crown 102 may be secured to the skirt 104 along a securement flange 150 of the crown 102. The securement flange 150 of the crown 102 may be secured to the skirt 104, e.g., by welding in a generally vertical orientation, i.e., longitudinally with respect to the piston assembly 100. Further, the securement flange 150 may extend along the skirt radially a distance L and longitudinally a height H. The height H may be smaller in magnitude than the radial extent L of the securement flange 150, i.e., where it contacts the skirt 104. Accordingly, an overall combined longitudinal or vertical thickness of the crown 102 and skirt 104 where they are joined may be minimized, thereby facilitating a generally longitudinal or vertical weld profile. More specifically, a longitudinal or vertical weld orientation may facilitate welding of the crown 102 and skirt 104 from a position above or below the crown 102 such that the weld and/or interface region 190, 192 encompasses a maximum extent of the crown 102 and skirt 104.

A longitudinal or vertically oriented weld may generally result in an elongated weld profile that extends longitudinally with respect to the piston axis. Furthermore, in contrast to traditional piston weld operations, e.g., friction welding, where welding operations are conducted solely below the crown 102 and beneath the combustion bowl surface S, a vertically oriented weld generally allows a weld tool, e.g., a laser, to weld the crown 102 to the skirt 104 from a top or bottom side of the crown 102.

In a first exemplary illustration shown in FIG. 1A, a welding laser L_{A} operates on the radially inner interface region 190 between the crown 102 and skirt 104 from a top side of the crown 102, i.e., above the combustion bowl area 120. Weld laser L_{A} generally welds the crown 102 to the skirt 104 by impinging upon the combustion bowl surface 120 of the crown 102 and/or skirt 104, e.g., adjacent mating surfaces 110, 114 and/or along the securement flange 150, thereby joining the crown 102 and skirt 104.

Alternatively, or in addition, a welding laser L_{B} may operate on a weld joint, e.g., at the radially inner interface region 190, between the crown 102 and skirt 104 from a bottom side of the crown 102, i.e., below the skirt 104. More specifically, weld laser L_{B} impinges upon a bottom surface 143 of the skirt upper portion 140, e.g., adjacent mating surfaces 110, 114 and/or along the securement flange 150, thereby welding the crown 102 and skirt 104 together.

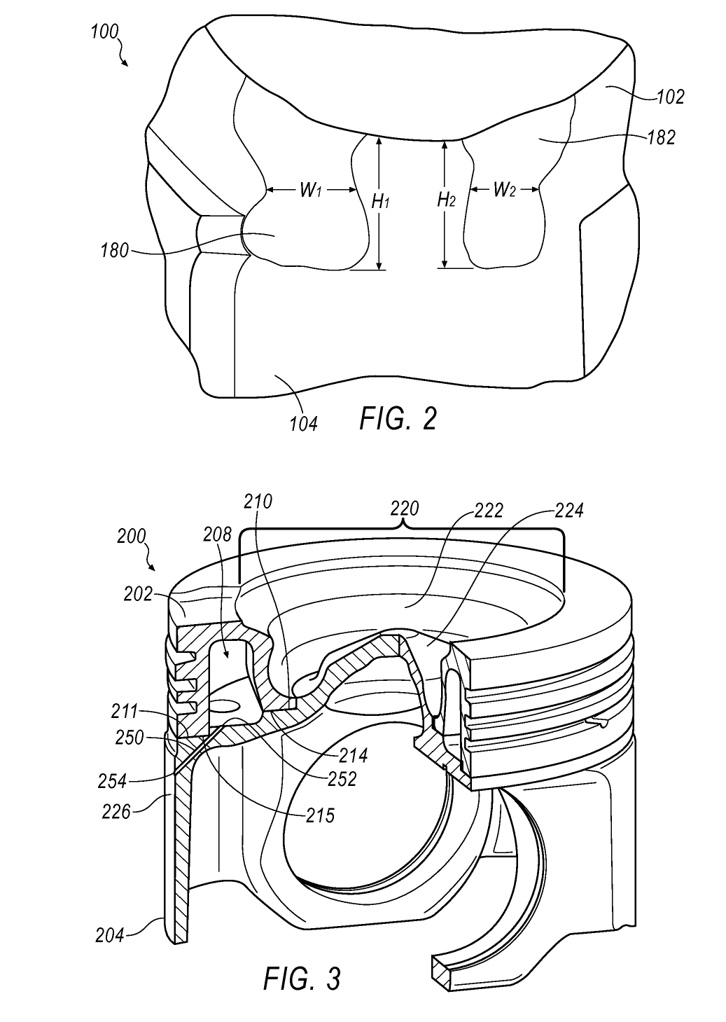

As noted above, welds may be formed in a series of distinct welds spaced about the perimeter of the crown 102, e.g., along the securement flange 150 and adjacent the central opening C of the crown 102. FIG. 2 illustrates, for example, two exemplary welds spaced apart from one another about the crown 102. More specifically, FIG. 2 is a cutaway view of a small portion of the crown 102 and the skirt 104 after formation of two adjacent welds 180, 182. The welds 180, 182 are oriented generally vertically or longitudinally. More specifically, as shown in FIG. 2 the welds 180, 182 each define radial widths about the perimeter of the crown 102, W₁ and W₂. The widths W₁ and W₂ are smaller in magnitude than their vertical heights H₁ and H₂ measured in a longitudinal direction with respect to the piston assembly 100, respectively. The welds 180, 182 may be of any size or configuration that is convenient. In the example illustrated in FIG. 2, the widths W₁ and W₂ are relatively small, and in some cases may be less than approximately 5 millimeters. A relatively small weld width similar to the welds 180, 182 may generally be facilitated where a number of welds are spaced about a perimeter of the crown 102.

As noted above, the radially outer mating surfaces 111, 115 of the crown 102 and skirt 104, respectively, may be in abutment due to the securement of the radially inner mating surfaces 110, 114, and need not be fixedly secured. Alternatively, the radially outer mating surfaces 110, 114 may be fixedly secured, e.g., by welding, bonding, or any other manner that is convenient. Fixed securement of both pairs of the radially outer and inner mating surfaces 110, 111, 114, and 115 may be desirable, for example, for particularly heavy-duty piston applications where maximum durability is desired.

By fixedly joining the piston crown 102 and the piston skirt 104, the piston assembly 100 is generally formed as a one-piece or “monobloc” assembly where the crown 102 and skirt 104 components are joined at interface regions 190, 192 that include the radially inner mating surfaces 110, 114 and radially outer mating surfaces 111, 115, respectively. That is, the piston crown 102 is generally unitized with the piston skirt 104, such that the piston skirt 104 is immovable relative to the piston crown 102 after securement to the crown, although the crown 102 and skirt 104 are separate components.

The piston crown 102 and piston skirt 104 may be constructed from any materials that are convenient. In one exemplary illustration, the crown 102 and skirt 104 are formed of the same material, e.g., steel. In another example, the piston crown 102 may be formed of a different material than the piston skirt 104. Accordingly, a material used for the piston crown 102 may include different mechanical properties, e.g., yield point, tensile strength or notch toughness, than the piston skirt 104. Any material or combination may be employed for the crown 102 and skirt 104 that is convenient. Merely as examples, the crown 102 and/or skirt 104 may be formed of a steel material, cast iron, aluminum material, composite, or powdered metal material. The crown 102 and skirt 104 may also be formed in different processes, e.g., the crown 102 may be a generally single cast piece, while the skirt 104 may be forged. Any material and/or forming combination may be employed that is convenient.

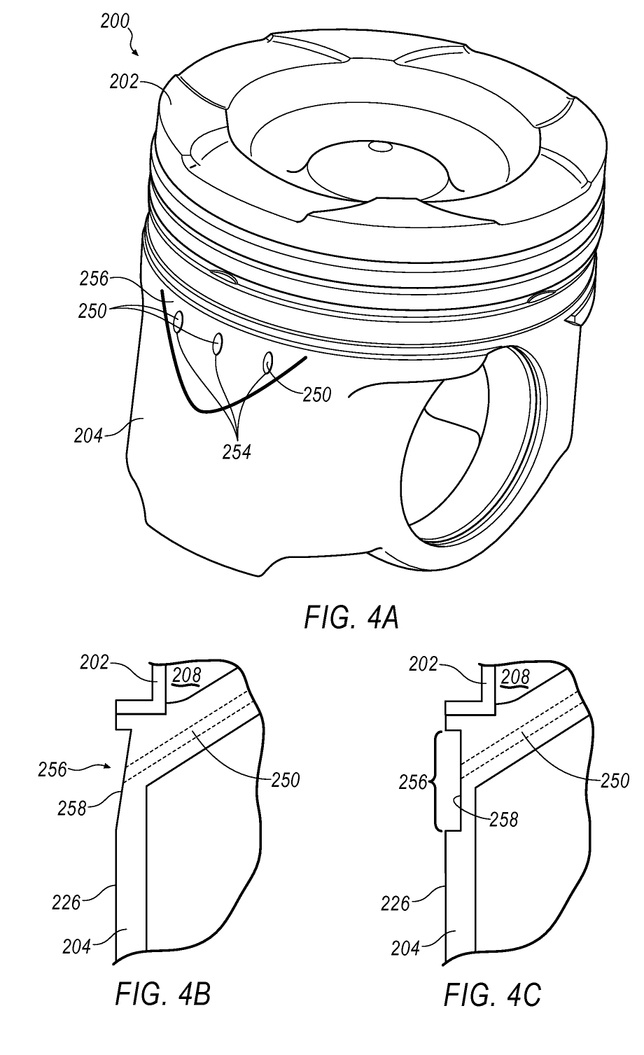

Referring now to FIGS. 3, 4A, 4B, and 4C, another exemplary piston assembly 200 is illustrated. The piston assembly 200 includes a crown 202 and skirt 204 that cooperate to form a cooling gallery 208, similar to piston assembly 100 described above. The crown 202 and skirt 204 may be secured to each other in any manner that is convenient. For example, similar to piston assembly 100, the crown 202 and skirt 204 of piston assembly 200 may be secured to each other along radially inner and outer mating surfaces 210, 211, 214, and 215 that each extend about at least a portion of a circumference of the crown 202 and skirt 204, respectively. One or both crown mating surfaces 110, 111 may be secured to their respective skirt mating surface 114, 115 in any manner that is convenient, e.g., by way of a welding operation or adhesive bonding, merely as examples, thereby securing the crown 102 and skirt 104 together.

The skirt 204 and crown 102 may cooperate to define a generally continuous upper combustion bowl surface S in the combustion bowl area 220 of the piston assembly 200, similar to piston assembly 100. For example, the corresponding mating surfaces 210 and 214 may meet within or adjacent the combustion bowl 220 such that the crown 202 defines a first radially outer portion 222 of the combustion bowl surface S. Further, the skirt 204 defines a radially inner portion 224 of the combustion bowl surface S.

Additionally, as best seen in FIGS. 3, 4A, 4B, and 4C, the skirt 204 may be provided with one or more lubrication passages 250 formed in the skirt 204 that allow fluid communication between the cooling gallery 208 and an outer surface 226 of the piston skirt during operation of the piston assembly 200. The passages 250 may generally allow a coolant or lubricant to travel through the skirt 204 to an outer surface 226 of the piston skirt 204, thereby improving lubrication between the skirt 204 and cylinder bore walls (not shown). Furthermore, the passages 250 generally allow for targeted lubrication of certain areas of the piston, e.g., a thrust-side of the piston assembly 200, anti-thrust side of the piston assembly 200, etc.

The lubrication passages 250 may be formed in any process that is convenient. In one exemplary illustration, the passages 250 are formed in a drilling process, such that the passages 250 define a generally straight path between an opening 252 of the passage 250 in the cooling gallery 208 (i.e., where lubricant may exit the cooling gallery) and an opening 254 of the passage at the outer surface 226 of the skirt (i.e., where lubricant may exit the passage). The passages 250 may be angled, e.g., running downward from the cooling gallery opening 252 to the skirt outer surface opening 254.

As best seen in FIGS. 4A, 4B, and 4C, the lubrication passages 250 may generally terminate along the outer surface 226 of the skirt. A relatively shallow depression or pocket 256 may be formed in the outer surface of the skirt to allow additional accumulation of a lubricant or coolant during operation. For example, as best seen in FIG. 4A, a pocket 256 in the outer surface 226 of the skirt 204 may include the openings 254 of each of three passages 250 formed in the skirt. Lubricants exiting the passages from the cooling gallery may thus tend to accumulate in the pocket 256, thereby enhancing lubrication in the area of the pocket 256.

The pocket 256 may be any size, shape, etc. that is convenient. For example, the pocket may generally be spaced away radially from outer surfaces of the skirt, e.g., outer surface 226 adjacent the pocket 256. In another exemplary illustration, the pocket 256 is spaced radially inwardly from the surface 226 approximately 20 to 80 micrometers. This depth may generally allow for accumulation of an amount of lubricant substantial enough to improve lubrication along the outer surfaces 226 of the skirt 204, while also minimizing any structural weakness of the skirt 204 resulting from the formation of the pocket 256, e.g., by thinning a wall of the skirt 104.

As best seen in FIG. 4B, an exemplary pocket 256 may be angled with respect to skirt outer surface 226. More specifically, the pocket 256 may have an inner surface 258 that is generally angled with respect to the skirt outer surface 226. Alternatively, as shown in FIG. 4C, the pocket 256 may be oriented generally longitudinally, such that inner surface 258 is oriented generally vertically and/or parallel with respect to the skirt outer surface 226.

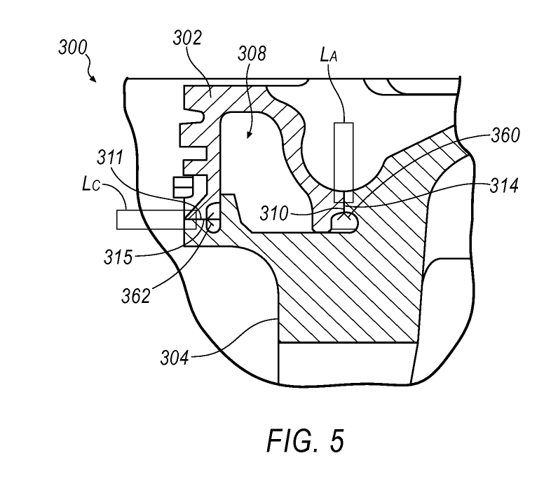

Turning now to FIG. 5, another exemplary piston assembly 300 is illustrated. Similar to piston assemblies 100, 200, piston assembly 300 may include a crown 302 and a skirt 304. The crown 302 and skirt 304 may cooperate to generally define a cooling gallery 308 through which a coolant, e.g., engine oil, may be circulated during operation of the piston assembly 300.

The crown 302 may also include radially inner and radially outer mating surfaces 310, 311, that are joined to radially inner and radially outer mating surfaces 314, 315, of the skirt 304, respectively. However, in contrast to the mating surfaces generally described above for piston assemblies 100, 200, radially inner mating surfaces 310, 314 of the crown 302 and skirt 304 are oriented generally longitudinally with respect to the piston assembly 300. More specifically, the radially inner mating surfaces 310, 314 define flat surfaces oriented generally longitudinally with respect to the piston assembly 300.

Additionally, a weld spatter trap 360 may be provided adjacent the mating surfaces 310, 314 to facilitate capture of any weld spatter during a welding operation associated with the mating surfaces 310, 314. More specifically, the crown 302 and skirt 304 may define corresponding cavities that form a gap or space into which weld spatter may flow during a welding operation. In one exemplary illustration, weld laser L_{A} operates upon the radially inner mating surfaces 310, 314 from a position above the crown 302 and skirt 304 such that any weld spatter accumulates within the weld spatter trap 360.

The weld spatter trap 360 may be provided anywhere a welding operation is performed upon mating surfaces 310, 314. For example, weld spatter trap 360 may be provided such that it extends generally continuously around at least a portion of the circumference of the piston crown 302 and skirt 304, as may be useful where welds are formed that extend about a corresponding circumference of the piston crown 302 and skirt 304, or a portion thereof. Alternatively a series of weld spatter traps 360 may be spaced about the circumference of the crown 302 and skirt 304, e.g., corresponding to positions where welds are provided about their circumference of the crown 302 and skirt 304.

Additionally, a second weld spatter trap 362 may be provided adjacent radially outer mating surfaces 311, 315 of the crown 302 and skirt 304. As shown in FIG. 5, the radially outer mating surfaces 311, 315 are oriented generally horizontally and are operated upon by a laser L_{c} that is in impinges upon the mating surfaces 311, 315 from a generally radially outer location with respect to the mating surfaces 311, 315. Accordingly, weld spatter may be generally captured within weld spatter trap 362, which is positioned radially inwardly with respect to the mating surfaces 311, 315, as the weld spatter flows radially inwardly away from the mating surfaces 311, 315.

The weld spatter traps 360, 362 may be formed using any method that is convenient. For example, the spatter traps 360, 362 may be formed as part of a forming process associated with the skirt 304 and/or the crown 302. Alternatively, the weld spatter traps 360, 362 may be separately formed in the crown 302 and/or the skirt 304, e.g., in a machining operation.

The provision of one or more weld spatter traps 360, 362 may advantageously allow the use of butt welds, which may offer increased strength and consistency of the weld joint as compared with, merely as an example, a lap joint.

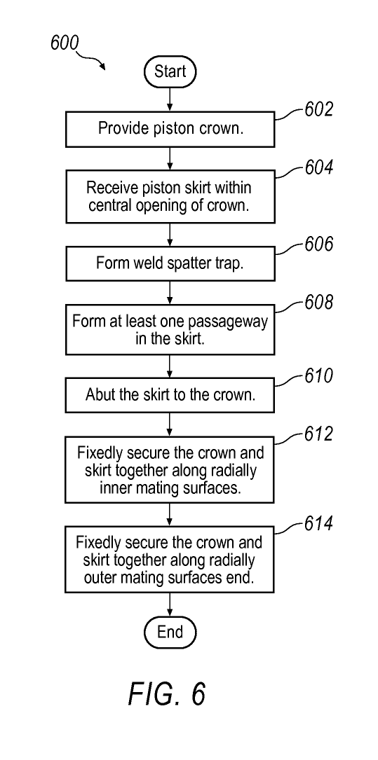

Turning now to FIG. 6, a process flow diagram for an exemplary process 600 of making a piston assembly is illustrated. Process 600 may generally begin at block 602, where a piston crown is provided. For example, a piston crown 102 may be provided that generally includes a ring belt portion 106 defining at least in part a cooling gallery 108. Further, the piston crown 102 may include radially inner and outer crown mating surfaces 110, 111 as described above.

Proceeding to block 604, a piston skirt may be received in a central opening of the crown. For example as described above a piston skirt 104, 204, 304 may be received within a central opening C of the crown 102, 202, 302. Further, the crown and skirt make cooperate to form a continuous upper combustion bowl surface, e.g. combustion bowl surface S. The radially inner and outer crown mating surfaces and skirt mating surfaces may extend substantially about an entire circumference of the crown and skirt, respectively. The crown 102 may also include a securement flange 150 extending around the central opening C, e.g., adjacent the radially inner mating surfaces 110, 114 of the crown 102 and skirt 104. Additionally a longitudinal height of the securement flange 150 may be smaller than a radial extent of the securement flange 150 that contacts the skirt 104. Process 600 may then proceed to block 606.

In block 606, one or more weld spatter traps may be formed adjacent at least one of the radially inner and outer mating surfaces of the crown and skirt. For example, as described above weld spatter traps 360 and or 362 may be formed in crown 302 and skirt 304 such that the weld spatter traps 360, 362 are positioned adjacent mating surfaces where weld spatter is likely to be directed during an associated welding operation. As noted above, weld spatter traps 360, 362 may be formed using any process that is convenient, e.g., as part of a forming process associated with crown 302 and/or skirt 304, or in a separate forming process such as machining Process 600 may then proceed to block 608.

At block 608, at least one passageway may be formed in the skirt. For example, as described above a passageway 250 may be provided that extends from a cooling gallery surface to an outer surface, e.g., skirt outer surface 226, of the piston assembly. Further, a depression or pocket 256 may be provided to accumulate coolant or lubricant received from the passageway 250.

Proceeding to block 610, the crown and skirt may be abutted along the corresponding radially inner and outer mating surfaces of the skirt and crown, such that the skirt generally encloses the cooling gallery. For example, as described above, radially inner and outer mating surfaces 110, 111 of the crown 102 may be abutted with the radially inner and outer mating surfaces 114, 115 of the skirt 104, respectively. Further, an upper portion 140 of the skirt 104 may generally enclose the cooling gallery 108 that is defined by the crown 102. Additionally, a securement flange 150 of the crown 102 may be abutted against the upper portion 140 of the skirt 104. Process 600 may then proceed to block 612.

At block 612, the crown and skirt may be fixedly secured together along the radially inner mating surfaces 110, 114 of the crown 102 and skirt 104, respectively. For example as described above the crown 102 and skirt 104 may be welded together along the radially inner mating surfaces 110, 114 of the crown 102 and skirt 104, respectively. Moreover, the welding operation may employ a laser welding tool that generally directs a laser beam, e.g. weld laser L_{A} and/or laser L_{B} generally longitudinally with respect to the piston assembly 100 toward the radially inner mating surfaces 110, 114 of the crown 102 and skirt 104, respectively. Where one or more weld spatter traps, e.g., weld spatter traps 360, are provided, welding the radially inner mating surfaces together may include directing the weld spatter into the weld spatter trap 360. Process 600 may then proceed to block 614.

At block 614, the crown 102 and skirt 104 may be fixedly secured along radially outer mating surfaces of the crown and skirt. For example, as described above radially outer mating surfaces 111, 115 of the crown 102 and skirt 104 may be welded together. Further, in another exemplary illustration described above, radially outer mating surfaces 311, 315 of the crown 102 and skirt 104, respectively, are welded together using a weld laser L_{c} that is radially directed with respect to the mating surfaces 311, 315 such that weld spatter is directed into an adjacent weld spatter trap 362. Process 600 may then terminate.

The exemplary pistons 100, 200, 300 and process 600 illustrated herein generally may allow for improved cooling performance as a result of the cooling galleries formed within the piston assemblies. Further, the piston assemblies 100, 200, and 300 may also offer improved piston guidance and dynamics, optimized viscous force for improved friction resulting from optimization of lubrication about the piston assemblies. Further, the welding methodologies disclosed also offer reduced manufacturing cost as a result of the manufacturing flexibilities offered by the vertical weld orientation.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A piston assembly, comprising:
a piston crown, including a ring belt portion defining at least in part a cooling gallery, the crown including radially inner and outer crown mating surfaces; and
a piston skirt received in a central opening of the crown such that the crown and skirt cooperate to form an upper combustion bowl surface, the skirt including a radially inner skirt mating surface abutted along a radially inner interface region with the radially inner crown mating surface, the skirt including a radially outer skirt mating surface abutted along a radially outer interface region with the radially outer crown mating surface such that the cooling gallery is substantially enclosed.

2. The piston assembly of claim 1, wherein each of the inner and outer crown mating surfaces and the inner and outer skirt mating surfaces extend about substantially an entire circumference of the crown and skirt.

3. The piston assembly of claim 1, wherein the crown includes a securement flange extending around the central opening adjacent the radially inner mating surfaces of the crown and skirt, wherein a longitudinal height of the securement flange is smaller than a radial extent of the securement flange, the radial extent of the securement flange contacting the skirt.

4. The piston assembly of claim 1, wherein the crown and skirt are fixedly secured together by the radially inner interface region, including the radially inner mating surfaces of the crown and skirt.

5. The piston assembly of claim 4, wherein the crown and skirt are welded together along the radially inner mating surfaces of the crown and skirt.

6. The piston assembly of claim 4, wherein the crown and skirt are fixedly secured together along the radially outer mating surfaces of the crown and skirt.

7. The piston assembly of claim 1, wherein the piston skirt defines at least one passageway extending from a cooling gallery surface to an outer surface of the piston assembly, the cooling gallery surface defining at least in part the cooling gallery.

8. The piston assembly of claim 7, wherein the outer surface is configured to slide along a cylinder bore surface during engine operation.

9. The piston assembly of claim 7, wherein the outer surface of the piston assembly is spaced away from a radially outer surface of the piston skirt such that the skirt defines a pocket.

10. The piston assembly of claim 1, wherein the crown defines a radially outer portion of the combustion bowl surface and the skirt defines a radially inner portion of the combustion bowl surface.

11. A method, comprising:
providing a piston crown including a ring belt portion defining at least in part a cooling gallery, the piston crown including radially inner and outer crown mating surfaces;
receiving a piston skirt in a central opening of the crown such that the crown and skirt cooperate to form a continuous upper combustion bowl surface having a radially inner portion defined by the skirt and a radially outer portion defined by the crown, the piston skirt including radially inner and outer skirt mating surfaces; and
abutting the skirt to the crown along the corresponding radially inner and outer mating surfaces of the skirt and crown such that the skirt and crown are abutted along a radially inner interface region including the radially inner mating surfaces of the crown and skirt and the skirt and crown are abutted along a radially outer interface region including the radially outer mating surfaces of the crown and skirt, the skirt thereby generally enclosing the cooling gallery.

12. The method of claim 11, further comprising establishing each of the radially inner and outer crown mating surfaces and each of the inner and outer skirt mating surfaces as extending about substantially an entire circumference of the crown and skirt, respectively.

13. The method of claim 11, further comprising establishing the crown as including a securement flange extending around the central opening adjacent the radially inner mating surfaces of the crown and skirt, a longitudinal height of the securement flange being smaller than a radial extent of the securement flange, the radial extent of the securement flange contacting the skirt.

14. The method of claim 11, further comprising fixedly securing the crown and skirt together by the radially inner interface region, including the radially inner mating surfaces of the crown and skirt.

15. The method of claim 14, wherein fixedly securing the crown and skirt together includes welding the crown and skirt together along the radially inner mating surfaces of the crown and skirt.

16. The method of claim 15, further comprising establishing welding the skirt to the crown as laser welding the skirt to the crown.

17. The method of claim 16, wherein laser welding the skirt to the crown includes directing a weld laser generally longitudinally with respect to the piston toward the radially inner mating surfaces of the crown and skirt.

18. The method of claim 14, further comprising fixedly securing the crown and skirt together along the radially outer mating surfaces of the crown and skirt.

19. The method of claim 11, further comprising forming at least one passageway in the skirt, the passageway extending from a cooling gallery surface to an outer surface of the piston assembly, the cooling gallery surface defining at least in part the cooling gallery.

20. The method of claim 11, further comprising:
forming a weld spatter trap adjacent at least one of the radially inner and outer mating surfaces of the crown and skirt;
welding the at least one of the radially inner and outer mating surfaces together, thereby directing heated material into the weld spatter trap on an opposite side of a weld joint associated with the at least one of the radially inner and outer mating surfaces.
